(19) United States
(12) Patent Application Publication
(10) Pub. No.: US 2013/0006881 A1
(43) Pub. Date: Jan. 3, 2013

(54) METHOD OF IDENTIFYING RELEVANT USER FEEDBACK

(75) Inventor: Reinhard KLEMM, Basking Ridge, NJ (US)

(73) Assignee: Avaya Inc., Basking Ridge, NJ (US)

(21) Appl. No.: 13/173,983

(22) Filed: Jun. 30, 2011

(51) Int. Cl. G06Q 30/00; G06Q 99/00

(52) U.S. Cl. 705/319; 705/347

(57) ABSTRACT

Disclosed herein are systems, methods, and non-transitory computer-readable storage media for sorting and outputting, base on relevancy, feedbacks to a user. For example, user characteristics of a user associated with viewing an item can be received directly from the user or from a social network profile associated with the user. The received user characteristics can be compared to user characteristics associated with feedbacks to yield respective degrees of similarity. Finally, the feedbacks can be output to the user based on the respective degrees of similarity.

### BACKGROUND

1. Technical Field

The present disclosure relates to user interfaces and more specifically to providing relevant information to users.

2. Introduction

People give businesses feedback because they wish to give their opinion on a good or service to other customers or to give suggestions for improvements. In online stores, this information is often provided in a list with a limited ability to search or sort. For example, the list can include a set of feedbacks that can be presented in order of date of the feedback. Sometimes the feedbacks can be sorted by some basic parameters, for example, most helpful/relevant or by rating, e.g., products rated 1-5 (1=poor . . . 5=excellent). For example, Amazon.com allows users to rate an item between 1 and 5 stars and provide a short text description of their rating. Similarly, Newegg.com allows users to provide feedback of 1 egg to 5 eggs and three text field describing pros, cons, and other thoughts.

Other customers and potential customers can use this feedback when making purchasing decisions. For example, if a good or service was given generally favorable reviews, the potential customer might be more likely to purchase the same good or service because others have given positive feedbacks. Alternatively, the potential customer might be less likely to purchase a good or service if feedbacks are generally negative, unless the details of the feedbacks are not a concern to the user, for example, if feedbacks claim a smartphone has poor Bluetooth™ connectivity, the potential customer might not be concerned because he does not plan on using the Bluetooth™ feature. Thus, feedbacks from previous customers can be very useful to potential customers. Customers typically trust feedback from other impartial customers who do not have an interest in promoting or malign the particular product or service.

Others, such as experts, can also provide feedbacks or reviews. Experts can be paid reviewers or volunteer collaborators with verified credentials to provide additional value to potential customers. In some instances, a potential customer might prefer to follow the advice of an expert rather than other customers. For example, when purchasing a PC having many features and options, ordinary customers might not be qualified to render a full opinion on all of the features, and an expert evaluation might carry more weight due to the complexity of the PC. However, it is up to a potential customer's discretion which reviews to give deference to, as all reviews/feedbacks can be displayed together.

Feedback can be invaluable to businesses that provide the goods or services too. Businesses can use negative feedbacks as suggestions for improving goods or services. For example, if a business learns, as described above, that a Bluetooth™ feature is not working properly, they can take remedial measures, such as redesigning the product or issuing a software update. Additionally, positive feedbacks can be used by businesses as a way of promoting their business or increase sales. These feedbacks can be prominently presented to potential customers as a way of objectively demonstrating the value of the good or service through unbiased, previous-customer feedback. Thus, feedback is beneficial to both customers and businesses.

Businesses are constantly seeking new and better ways to curate information for their customers. Curating information results in higher relevancy, greater efficiency and an overall better user experience. For example, computer users are generally familiar with using search engines such as Google™ and Bing™. These search engines attempt to curate as much information on the internet as possible. As an example, a user can input a search string into the search engine, and the search engine can return a listing of information determined to be relevant to the user. The more relevant the information obtained by the search, the better the user experience will be.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As valuable as online feedback from previous customers is to other customers and businesses, each customer feedback raises the question of relevance to the observer, i.e., to which degree the feedback should influence the observer's decision-making or spur the observer into action. In the above example of a customer reporting a defective Bluetooth™ feature in a smartphone, how seriously should the business that sells or manufactures the smartphone take this feedback? How seriously should a customer who is interested in the smartphone and particularly its Bluetooth™ feature take this feedback? Relevance of customer feedback to the observer is extremely difficult to measure, even under theoretical conditions with perfect knowledge about the feedback provider, the good or service being evaluated, and the observer. A large number of variables can affect the feedback relevance, and thee variables may not have a clear mapping to a single relevance value. This disclosure presents several practical strategies to cope with the lack of complete knowledge and the difficulty of measuring relevance. For example, if only a handful of customers provide hundreds of feedback about the Bluetooth™ problem, the business and other customers may decide to ignore this negative feedback. Feedback relevance also heavily depends on the characteristics of the feedback providers. Suppose a customer C bought the smartphone in the above example and complained about the Bluetooth™ feature not working properly. The relevance of this negative feedback may be strongly influenced by C's characteristics. If C is a centenarian with no affinity to modern communication and networking technology and who is a first-time smartphone buyer, with the most modern piece of technology in C's household so far being a 1970s television set, the observer may decide to discount or otherwise marginalize C's feedback. Likewise, if C worked for the WiFi™ Alliance (WiFi™ is a Bluetooth™ competitor of sorts), C may be deliberately or subconsciously biased against Bluetooth™ and for this reason provide negative feedback, in which case the observer may also decide to assign no or low relevance to C's feedback. Traditionally, obtaining reliable information about the feedback providers' characteristics, however, is difficult or impossible. Embodiments of the present disclosure seek to address the how to measure relevancy based on user characteristics.

Disclosed are systems, methods, and non-transitory computer-readable storage media for sorting and/or filtering user feedbacks using user characteristics, similarity, and dissimilarity between user characteristics. This approach can be advantageous to find feedback from others that are similar to a particular demographic or persuasion. For example, a technically unsavvy, vision-impaired, high-school drop-out, 20-year-old male, whose interests revolve around riding his motorcycle on a dirt track and watching Beavis and Butthead episodes on TV, might rate, in his feedback, the goods and services of an online literature bookseller as “poor.” Whereas a 60-year-old female that is self-proclaimed computer wiz and philology professor might not give the rating from the 20-year-old male much weight. The 60-year-old female might want to find ratings from people either her age or with more advanced educations. In many cases, as the similarity between a reviewer and a potential customer increases, the potential relevance of reviews and feedback from that reviewer to the potential customer also is very likely to increase. In other cases, dissimilarity between a feedback provider and an observer may increase relevance. For example, a technologically inexperienced customer may find feedback from technologically savvy customers more relevant than from those who are just as inexperienced. Further, businesses that seek to target a particular demographic for increased sales might desire to identify feedback from a particular segment of society. For example, if a product is popular with 20-30-year-olds, but not 30-40-year-olds, the business might want to review feedback given by the 30-40-year-olds to determine why the good or service is not successful with that segment of society. Using this information, more-focused advertising can be purchased, or product modifications can be made to increase sales. For businesses, relevance of customer feedback for improving or changing its offerings may also depend on other customer characteristics such as their affiliations (working for a competitor, being part of a fan club for the business, etc.), profession, education, lifestyle, etc.

### BRIEF DESCRIPTION OF THE DRAWINGS

To describe the manner in which the advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example system embodiment for determining characteristics of a user;

FIG. 3 illustrates an example list of user feedbacks;

FIG. 4 illustrates an example list of user feedbacks utilizing social network profile information;

FIG. 5 illustrates an exemplary adjustable user interface element;

FIG. 6 illustrates a second exemplary adjustable user interface element; and

FIG. 7 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations can be used without departing from the spirit and scope of the disclosure.

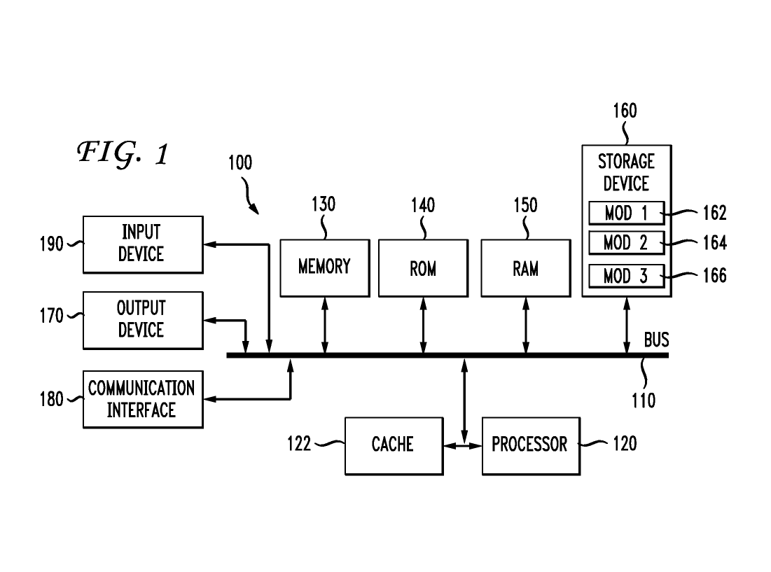

The present disclosure addresses the need in the art for providing relevant feedbacks to a user. A system, method and non-transitory computer-readable media are disclosed which can be used to filter and/or provide relevant user feedbacks to a user based on a comparison of user characteristics. A brief introductory description of a basic general purpose system or computing device in FIG. 1 which can be employed to practice the concepts is disclosed herein. A more detailed description of the system, method and non-transitory computer-readable media will then follow. These variations shall be discussed herein as the various embodiments are set forth. The disclosure now turns to FIG. 1.

With reference to FIG. 1, an exemplary system 100 includes a general purpose computing device 100, including a processing unit (CPU or processor) 120 and a system bus 110 that couples various system components including the system memory 130, such as read only memory (ROM) 140 and random access memory (RAM) 150, to the processor 120. The system 100 can include a cache 122 of high speed memory connected directly with, in close proximity to, or integrated as part of the processor 120. The system 100 can copy data from the memory 130 and/or the storage device 160 to the cache 122 for quick access by the processor 120. In this way, the cache can provide a performance boost that avoids processor 120 delays while waiting for data. These and other modules can control or be configured to control the processor 120 to perform various actions. Other system memory 130 can be available for use as well. The memory 130 can include multiple different types of memory with different performance characteristics. It can be appreciated that the disclosure can operate on a computing device 100 with more than one processor 120 or on a group or cluster of computing devices networked together to provide greater processing capability. The processor 120 can include any general purpose processor and a hardware module or software module, such as module 1 (162), module 2 (164), and module 3 (166) stored in storage device 160, configured to control the processor 120 as well as a special-purpose processor where software instructions are incorporated into the actual processor design. The processor 120 can essentially be a completely self-contained computing system, containing multiple cores or processors, a bus, memory controller, cache, etc. A multi-core processor can be symmetric or asymmetric.

The system bus 110 can be any of several types of bus structures including a memory bus or memory controller, a peripheral bus, and a local bus using any of a variety of bus architectures. A basic input/output (BIOS) stored in ROM 140 or the like, can provide the basic routine that helps to transfer information between elements within the computing device 100, such as during start-up. The computing device 100 can further include storage devices 160 such as a hard disk drive, a magnetic disk drive, an optical disk drive, a tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media can provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, output device 170 (e.g., display), and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiments of FIG. 1 employ the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, can also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction of operating on any particular hardware arrangement, and therefore the basic features here can easily be substituted for improved hardware or firmware arrangements as they are developed.

For clarity of explanation, the illustrative system embodiment is presented as including individual functional blocks including functional blocks labeled as a “processor” or processor 120. The functions these blocks can be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors presented in FIG. 1 can be provided by a single shared processor or multiple processors. (Use of the term “processor” should not be construed to refer exclusively to hardware capable of executing software.) Illustrative embodiments can include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, can also be provided.

The logical operations of the various embodiments can be implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three software modules 162, 164, 166, which are modules configured to control the processor 120. These modules can be stored on the storage device 160 and loaded into RAM 150 or memory 130 at runtime or can be stored as would be known in the art in other computer-readable memory locations.

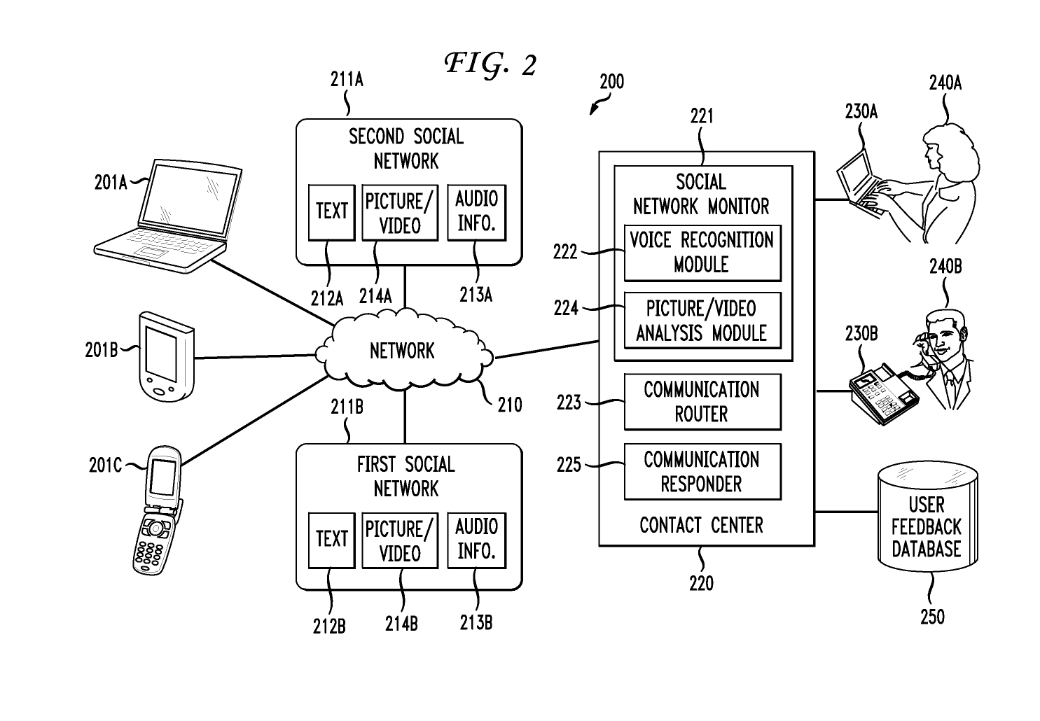

Having disclosed some components of a computing system, the disclosure now turns to FIG. 2, which illustrates a block diagram of a first illustrative system 200 for determining characteristics of a person. The system 200 includes communication devices 201A, 201B, 201C, a network 210 such as a local area network and/or the Internet, social networks 211A, 211B such as Facebook, Twitter, and LinkedIn, a contact center 220, agent terminals 230A, 230B, and agents 240A, 240B. The contact center 220 can be a computer or server that includes a social network monitor 221, a communication router 223, and a communication responder 225. Additionally, the social network monitor 221 can include a voice recognition module 222 and/or a picture/video analysis module 224. The communication devices 201A, 201B, 201C can be any type of device that can communicate on the network 210 such as a Personal Computer (PC), a laptop computer, a smartphone, a tablet, a telephone, a cellular telephone, a server, a Private Branch Exchange (PBX), and any other network-enabled device. Illustratively, communication device 201A is shown as a laptop computer, communication device 201B is shown as a smartphone, and communication device 201C is shown as a cellular telephone.

The network 210 can be any type of network using any type of protocol such as the Internet, a Local Area Network (LAN), a Wide Area Network (WAN), the Public Switched Telephone Network (PSTN), a packet-switched network, an ATM network, a wireless network, a cellular network, a wired network, and any combination thereof. Social networks 211A, 211B can be any type of network where people converse, such as a blog site, a web site, Facebook™, Twitter™, a Real Simple Syndication (RSS) feed, a voice conference call, and the like. Social networks 211A, 211B are shown separate from network 210 for illustrative purposes; however, social networks 211A, 211B can also be entirely or partially integrated as part of network 210. Social networks 211A, 211B can further include text 212A, 212B and/or audio information 213A, 213B. The text 212A, 212B can be, for example, text written by a person on a blog site, the text on the person's Facebook page, text on the person's web site, text of an RSS feed the person subscribes to, personal characteristics, and the like. The audio information 213A, 213B can be speech in an RSS feed, speech of a conference call, speech of a telephone call, an audio file, a music file, and the like. The audio information 213A, 213B can be, for example, files/information placed on a person's Facebook page such as music files, audio files, an audio portion of a video, and the like.

The contact center 220 can include a social network monitor 221 and a communication router 223. The social network monitor 221 can communicate via the network 210 with social networks 211A, 211B via application programming interface (API) calls, for example. The contact center 220 can be any contact center 220 that can handle communications from a person and/or agents 240. For example, the contact center 220 can handle voice communications, text communications, video communications, various combinations of these, and the like. The contact center 220 can include manually conducted contact with customers or can be entirely or partially automated.

The social network monitor 221 is any system that can search one or more social networks 211 such as a server, a Private Branch eXchange (PBX), and the like. The social network monitor 221 can search the social network(s) 211 in various ways. For example, the social network monitor 221 can search the social networks 211 by actively searching the social networks 211, by passively searching the social networks 211, by searching the social networks 211 periodically, based on detection of an event in the social network 211, based on a time period, based on a new post of a person, based on previous posts of a person (e.g., historical posts of a person), and the like. The social network monitor 221 is shown illustratively as part of the contact center 220, however, the social network monitor 221 can be separate from the contact center 220. The social network monitor 221 further can further include a voice recognition module 222. The voice recognition module 222 can be any device/software that can transcribe received audio information into text. The voice recognition module 222 can transcribe audio information, in either analog or digital form, into text using any manner of voice recognition hardware or software as is known in the art.

The communication router 223 can be any device capable of routing communications between a person and an agent 240 such as a PBX, a mail server, a router, an Instant Messaging (IM) server, a video server, an Interactive Voice Response (IVR) system, and the like. The communication router 223 is illustratively shown as part of the contact center 220; however, the communication router 223 can be separate from the contact center 220.

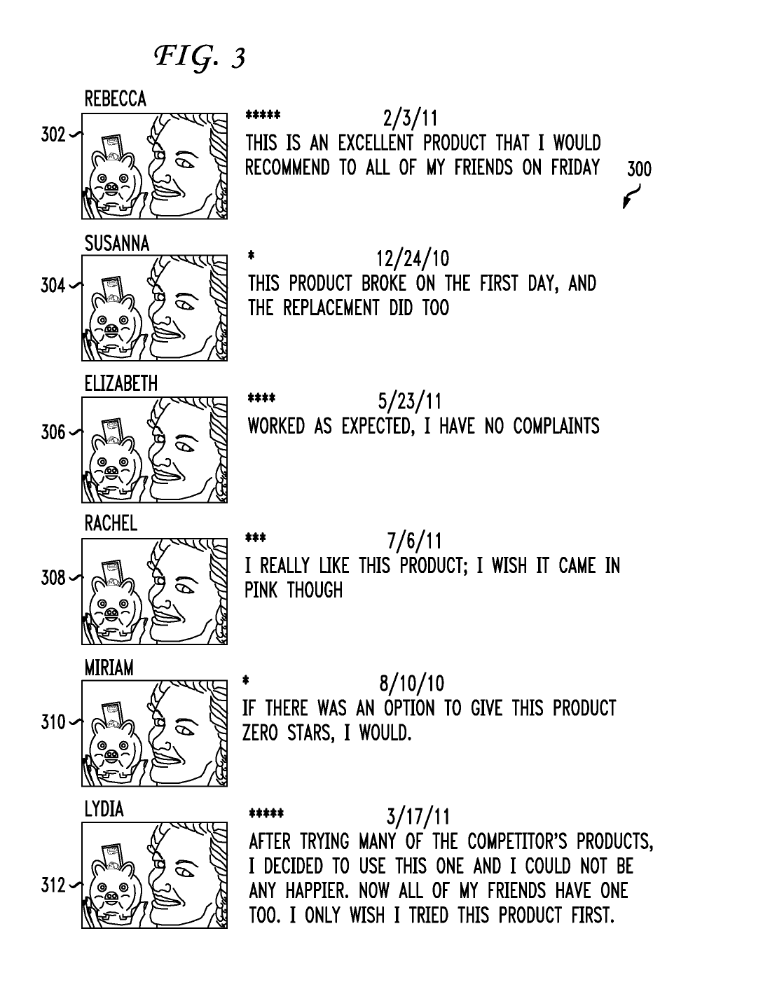

The agent terminals 230A, 230B can be any type of device that allows the agents 240A, 240B to communicate with a person such as a personal computer, a terminal, a telephone, and the like. The agents 240A, 240B are shown figuratively as people, but can include automated systems, such as a web-based form for receiving feedback and/or ratings at an online merchant website. During a customer call to one of the agent terminals 230B, the agent terminal 230B, can ask the user for feedback on the user's experience with a product or service, and voice recognition module 222 can transcribe the feedback into text, which can be added to the feedbacks of FIG. 3.

The block diagram of FIG. 2 illustrates social networks 211A, 211B including picture/video 214A, 214B, text 212A, 212B, and audio information 213A, 213B. Pictures/video 214A, 214B can be any type of picture, video, or image, such as a picture of a person, place, and the like. Pictures/video 214A, 214B can include text 212A, 212B or Global Positioning Satellite (GPS) coordinates of where the picture/video 214 was taken, for example. For example, the person can have posted a picture 214A, 214B of themselves in front of their apartment building on the web page of their social network 211A, 211B that has GPS coordinates of where the picture 214A, 214B was taken. Pictures/video 214A, 214B can be a video file, a video stream, and/or a live video stream.

The social network monitor 221 can further include a picture/video analysis module 224. The picture/video analysis module 224 can be any device/software that is capable of identifying a location of where a picture/video 214A, 214B was taken such as a server, a software application, and the like. The picture/video analysis module 224 can also determine user characteristics, such as gender, race, age, and fashion style. The picture/video analysis module 224 is shown as part of the social network monitor 221, but could exist separate from the social network monitor 221.

The contact center 220 further includes a communication responder 225. The communication responder 225 can be any device/software that is capable of responding to an issue of a person that is in communication with the contact center 220, via, for example, laptop 201A.

In addition, the picture/video analysis module 224 can identify the location of picture/video 214B based on recognition of different objects in picture/video 214B. For example, the picture/video analysis module 224 can determine that picture/video 214B was taken in Paris based on recognition of the Eiffel Tower in the background. Knowing that the person has been to Paris can be used to determine if the person's nationality is French or whether they enjoy travel. This can also be done by examining a video file by looking at frames of the video file. Identifying objects in the video frames that were taken in a specific place can help determine user characteristics.

In addition, the picture/video analysis module 224 can identify text 212B and/or audio information 213B that is associated with the picture/video 214B on the second social network 211B. The text 212B and/or audio information 213B that is associated with the picture/video 214B can indicate where the picture/video 214B was taken. For example, if the person's name is John Smith and the picture/video 214B had an associated text 212B that states “John Smith's pictures from home.” The picture/video analysis module 224 can determine that John Smith lives in Paris based on picture/video 214B with the Eiffel Tower in the background. The associated text 212B can also be embedded into picture/video 214B. Another way to determine a location of where picture/video 214B is taken can be by Global Positioning Satellite (GPS). A camera/video camera can embed GPS coordinates into picture/video 214B or can output the coordinates for use by the person. Likewise, audio information can be associated with a picture/video 214A. For example, the audio track of a home movie could indicate where the home movie was taken, thus allowing the picture/video analysis module 224 to identify the location and user characteristics.

The communication responder 225 can take feedback from a user via, for example, communication over network 210. A user can input feedback onto a website associated with the contact center, and communication responder 225 can store the feedback in a user feedback database 250 for processing by an agent 240 or further processing by social network monitor 221. In addition to receiving feedback from the user, communication responder 225 can display an option to request permission from the user for access to a user's social network profile. For example, Facebook™ provides a service called Facebook Connect, which allows a user to grant access to certain user information, e.g., user characteristics. Once permission is granted, the social network monitor 221 can access the user's characteristics stored on the social network 211. These user characteristics can be associated, or correlated, and stored with the user's feedback to provide additional context to the user's feedback. Once user characteristics are identified, they can be downloaded and stored in a user profile or with feedback in user feedback database 250.

FIG. 3 illustrates a list 300 of user feedbacks 302, 304, 306, 308, 310, 312 presented in a list format as is known in the art. However, the system, method and computer-readable storage media of the present disclosure can present feedbacks that are more relevant to the user than a listing off all received feedback because, in this case, the feedback is all from women aged 30-40 that have characteristics in common with a hypothetical user, Sarah. In this example, Sarah is 37 years old, has a dog, and is looking for a new dog collar. Sarah is fashion conscious and therefore would like to see whether other women in her demographic approve of the style of the dog collar that she is viewing on a web page. In this case, the reviews seem to be fairly mixed, so Sarah can either keep searching for a different collar or choose this one. Alternatively, Sarah can choose to further refine the similarity to narrow the types of feedbacks displayed. For example, Sarah can indicate a specific type or age of dog that each reviewer owns. Miriam's negative feedback may be in connection with a boisterous young St. Bernard, while Elizabeth's positive feedback may be with a more mature and sedate Shih Tzu.

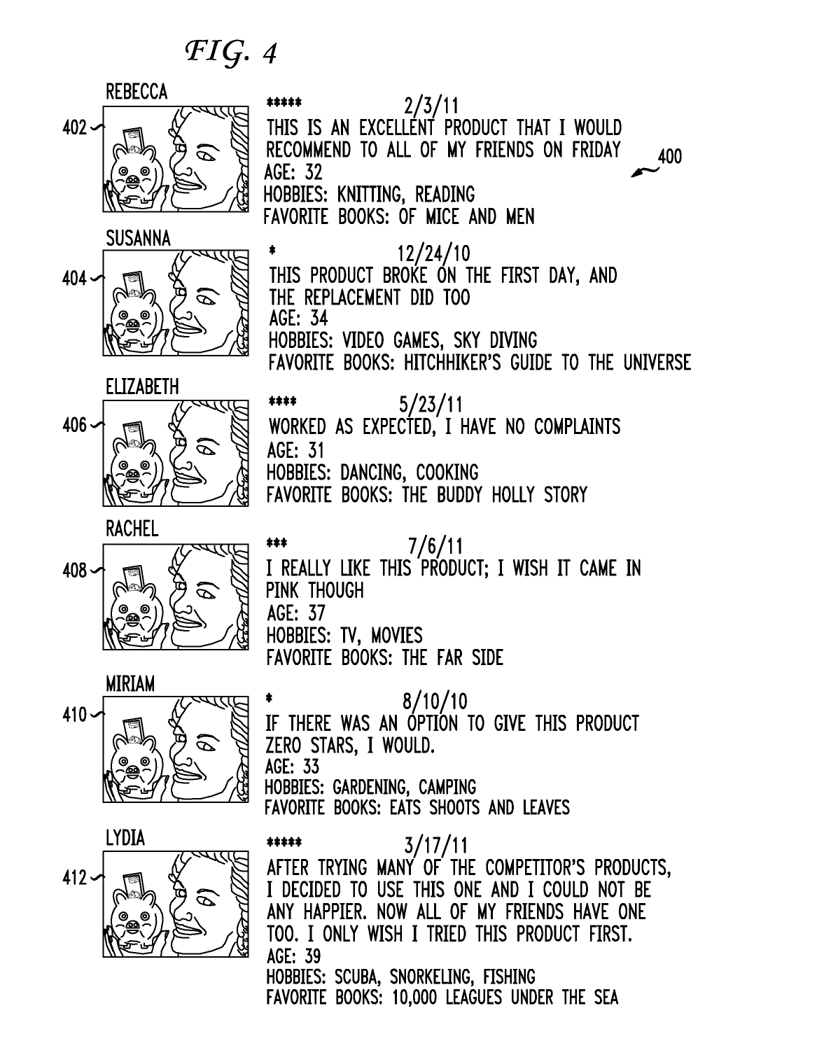

FIG. 4 illustrates a list 400 of user feedbacks 402, 404, 406, 408, 410, 412 similar to those shown in FIG. 3. However, this example incorporates user characteristics into the feedbacks. These exemplary user characteristics include age, hobbies and favorite books, but can also include virtually any single or multiple user characteristics associated with users providing feedback. By displaying the user characteristics, a potential customer can weight some feedbacks more than others based on the user characteristics. For example, a potential customer may weight feedback from people of a similar age with greater weight. Moreover, the potential customer can input user characteristic preferences to view only feedbacks from users in a particular age range, which in this example is between 30-40 years old, and only shows feedbacks from females.

In another embodiment, feedbacks, or signals representative of the feedbacks, can be output to a display in a sorted list based on received user characteristic preferences. For example, the contact center 220 can compare user characteristic preferences, or user characteristics associated with a user viewing an item, to user characters associated with feedbacks. In this manner, relevancy can be determined through the comparison, e.g., feedbacks with more matching user characteristics are more relevant or certain characteristics can be deemed more important, e.g. age. Finally, feedbacks can be output based on relevancy, e.g., with an indication of relevancy, such as a percentage, order of relevancy, or both in order and with an indication. The system can generate, based on a user's personal information, social networking profile, other feedback, and so forth, a multi-dimensional vector representing that user's interests and characteristics. The system can compare that multi-dimensional vector with other vectors representing users who have provided feedback on the past. The system can display to the user feedback that is associated with other users' vectors that are within a similarity threshold or a maximum distance with respect to the user's vector. The user can modify the vector, and consequently the subset of feedback that is displayed, in real time by adjusting which characteristics are factored into the vectors and how much weight to attribute to each of the vectors. The system can detect when a particular user is extremely similar to another user based on a distance or similarity between their respective vectors. If the system detects an extremely similar user, the system can then emphasize that user's feedback, when available, such as by altering the font type, size, or other attributes, by placing that user's feedback higher in the list, or by including a photograph, icon, and/or additional information with the feedback.

Businesses sometime compensate users for feedback, such as with cash, coupons or discounts. If an incentive is given for feedback, the list 400 of user feedbacks can include an indication, such as a ‘$’ symbol, that an incentive was given for the feedback. The indication could be used by a potential customer to give less weight to such feedback because the feedback is potentially biased.

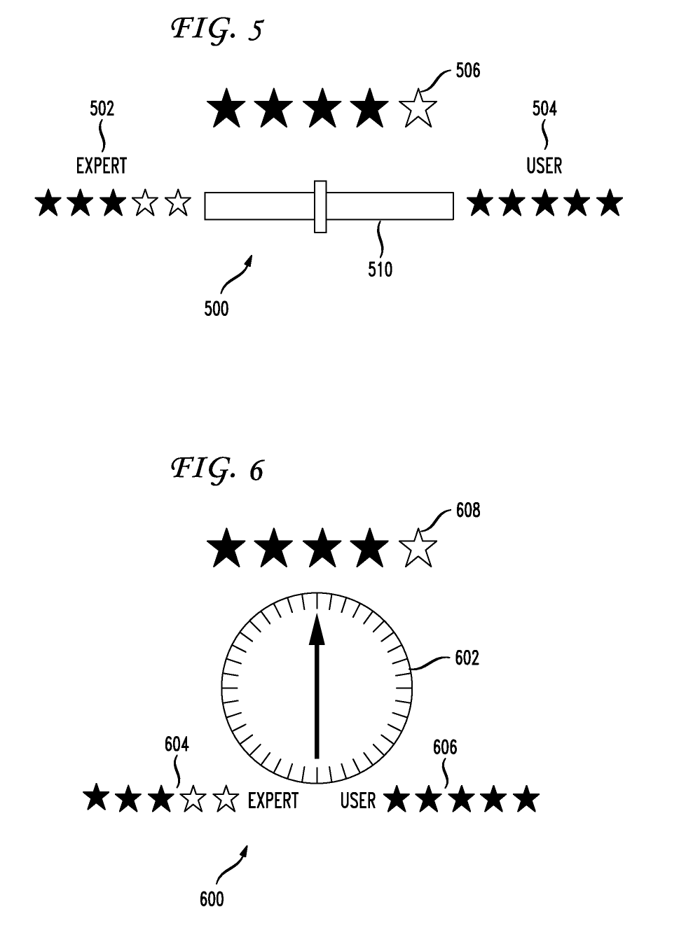

Expert feedbacks can be displayed with non-expert feedbacks. Along with sorting the expert and non-expert feedbacks based on date, etc., as described above, some embodiments include an adjustable user interface element is configured to control output of the relevant user feedbacks. FIG. 5 illustrates one exemplary user interface 500. A user can adjust a slider bar 510 to vary the weighting of expert ratings 502 (three stars) vs. user ratings 504 (five stars). Sliding the slider bar 510 to one end can cause display of only expert ratings, and sliding slider bar 510 to the other end can cause display of only user ratings. In the middle of the slider bar 510, some ratio of expert reviews to user reviews can be made such that the ratings that appear are in accordance with the ratio defined by the dial. In this example, the slider bar 510 is centered, which yields an aggregate rating 506 of four stars. In this manner, the aggregate rating 506 can represent all expert reviews, all user reviews, or some combination of the two.

FIG. 6 illustrates a second embodiment of an adjustable user interface 600. In this example, the slider bar 510 is replaced with a dial 602. The operation is similar in that rotating the dial 602 to one end yields only expert feedbacks 604, and the other end yields only user feedbacks 606 in the aggregate rating 608. Similarly, feedbacks displayed, for example in list 41, could represent the chosen ratio of expert to user feedbacks. Other examples of adjustable user interfaces include a number that can be increased or decreased by, for example, plus and minus buttons. The user interface can be styled after a graphic equalizer with multiple sliders or dials each representing at least one of multiple different attributes of the reviewers. Users can manipulate the user interface in real time, and the list of feedbacks is updated to reflect those manipulations.

Users can also control output of relevant user feedbacks based on other parameters, such as age, via the adjustable user interfaces 500, 600. For example, the adjustable user interfaces 510 and 600 could be used to present feedbacks from users within 5 years of an age indicated by the adjustable user interface.

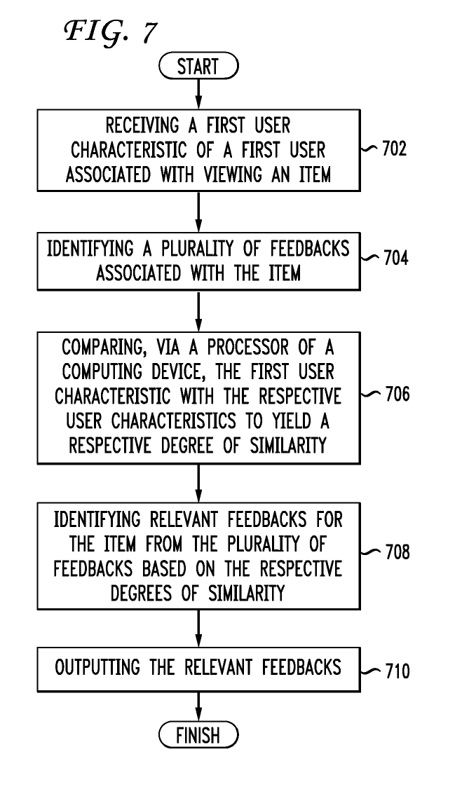

Having disclosed some basic system components and concepts, the disclosure now turns to the exemplary method embodiment 700 illustrated in FIG. 7. For the sake of clarity, the method 700 is discussed in terms of an exemplary system 100 as shown in FIG. 1 configured to practice the method 700. The steps outlined herein are exemplary and can be implemented in any combination thereof, including combinations that exclude, add, or modify certain steps. In this example, the system receives one or more user characteristics of a user associated with viewing an item (702). The user characteristic(s) can be received, for example, by the user inputting the characteristic into a form, from a social network profile associated with the user, from behavior determined by monitoring the user's internet activity, such as which items a user has viewed, or by looking at cookies stored on the user's computer. User characteristics include, age, date of birth, gender, and preferences or biographical information, e.g., favorite food, level of education, political persuasion, clothing, etc. The method 700 also includes identifying a set of feedbacks associated with the item (704). Each of the feedbacks can be associated with respective users and user characteristics.

The system can compare user characteristics associated with the set of feedbacks with the received user characteristic to yield respective degrees of similarity (706). For example, ages can be compared to see whether they are within five years of the age of the user associated with viewing the item. In another example, the system compares nationality, language, hobbies, or favorite books to determine similarities between the received user characteristics and the characteristics associated with the set of feedbacks. The system can optionally aggregate the number of similarities to yield the respective degree of similarity.

The system 100 identifies relevant feedbacks for the item from the set of feedbacks based on the respective degree of similarity (708). Finally the system outputs the relevant feedbacks to the user (710). The relevant user feedbacks can be presented to the user in, for example, a list as illustrated in FIGS. 3 and 4.

Embodiments within the scope of the present disclosure can also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium that can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure can be practiced in network computing environments with many types of computer system configurations, including personal computers, hand-held devices, multi-processor systems, microprocessor-based or programmable consumer electronics, network PCs, minicomputers, mainframe computers, and the like. Embodiments can also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed to limit the scope of the disclosure. For example, the principles herein could be used to sort feedback based on any number of characteristics beyond those described. Moreover, additional methods of output are contemplated, for example, tactile, e.g., Braille, auditory or visual outputs. Those skilled in the art will readily recognize various modifications and changes that can be made to the principles described herein without following the example embodiments and applications illustrated and described herein, and without departing from the spirit and scope of the disclosure.

1. A method comprising:
receiving at least one first user characteristic of a first user, wherein the first user is associated with viewing an item;
identifying a plurality of feedbacks associated with the item, wherein each respective feedback of the plurality of feedbacks is associated with a respective user having respective user characteristics;
comparing, via a processor of a computing device, the at least one first user characteristic with the respective user characteristics to yield respective degrees of similarity;
identifying relevant feedbacks for the item from the plurality of feedbacks based on the respective degrees of similarity; and
outputting the relevant feedbacks.

2. The method of claim 1, further comprising:
sorting the relevant feedbacks based on the respective degrees of similarity.

3. The method of claim 1, wherein the relevant feedbacks are outputted to one of a potential customer and a business representative.

4. The method of claim 1, further comprising:
displaying an option to allow access to a social network profile of the first user.

5. The method of claim 4, wherein receiving the at least one first user characteristic further comprises downloading the at least one first user characteristic from the social network profile.

6. The method of claim 1, further comprising:
displaying an indication of whether a user that provided one of the relevant feedbacks received compensation.

7. The method of claim 1, wherein the plurality of feedbacks comprises ratings.

8. The method of claim 1, further comprising:
displaying an adjustable user interface element that is configured to vary an importance of user ratings versus expert ratings.

9. The method of claim 7, wherein the adjustable user interface element is configured to control output of the relevant feedbacks, wherein at a first setting, only the expert ratings are outputted, and, at a second setting, only the user ratings are outputted.

10. A method comprising:
receiving user characteristics associated with users that provided user feedback associated with an item;
identifying, via a processor of a computing device, a plurality of feedbacks associated with the item, each respective feedback of the plurality of feedbacks being associated with a respective user having respective user characteristics;
correlating the user characteristics with the user feedback;
receiving at least one user characteristic preferences;
comparing, via the processor, the at least one user characteristic preferences with the user characteristics correlated with the user feedback, thereby determining respective degrees of similarity; and
outputting the user feedbacks with an indication of relevancy based on the respective degrees of similarity.

11. The method of claim 10, further comprising:
sorting the user feedbacks based on the respective degrees of similarity.

12. The method of claim 10, wherein the user feedbacks are outputted to one of a potential customer and a business representative.

13. The method of claim 10, further comprising:
displaying an option to allow access to a social network profile of a viewer.

14. The method of claim 13, wherein receiving the at least one first user characteristic comprises downloading the at least one first user characteristic from the social network profile.

15. The method of claim 10, further comprising:
indicating whether a user providing one of the user feedbacks received compensation.

16. The method of claim 10, wherein the plurality of feedbacks comprises ratings.

17. The method of claim 10 further comprising:
displaying an adjustable user interface element that is configured to vary the importance of user ratings versus expert ratings.

18. The method of claim 17, wherein the adjustable user interface element is configured to control output of the relevant feedbacks to display, at a first setting, only the expert ratings, and at a second setting, only the user ratings.

19. A non-transitory computer-readable storage medium storing instructions which, when executed by a computing device, cause the computing device to perform steps comprising:
receiving at least one first user characteristic of a first user, wherein the first user is associated with viewing an item;
identifying a plurality of feedbacks associated with the item, each respective feedback of the plurality of feedbacks being associated with a respective user having respective user characteristics;
comparing, via a processor of a computing device, the at least one first user characteristic with the respective user characteristics to yield respective degrees of similarity;
identifying relevant feedbacks for the item from the plurality of feedbacks based on the respective degrees of similarity; and
outputting the relevant feedbacks.

20. The non-transitory computer-readable storage medium of claim 19 further comprising:
sorting the relevant feedbacks based on the respective degrees of similarity.
